(19) United States
(12) Patent Application Publication
(10) Pub. No.: US 2011/0319140 A1
(43) Pub. Date: Dec. 29, 2011

(54) DISPLAY DEVICE

(75) Inventor: Masaki KANBE, Osaka (JP)

(73) Assignee: KYOCERA CORPORATION, Kyoto (JP)

(21) Appl. No.: 13/170,540

(22) Filed: Jun. 28, 2011

(30) Foreign Application Priority Data
Jun. 28, 2010 (JP) 2010-146765

(51) Int. Cl. H04W 88/02

(52) U.S. Cl. 455/566

(57) ABSTRACT

A system and method for operating a mobile electronic device is disclosed. A shift of a first housing relative to a second housing comprising a display is detected, and an amount of shielding of the display by the first housing is determined. An image is displayed on the display based on the amount of shielding.

### CROSS-REFERENCE TO RELATED APPLICATION

The present application claims priority under 35 U.S.C. §119 to Japanese Patent Application No. 2010-146765, filed on Jun. 28, 2010, entitled “MOBILE TERMINAL”. The content of which is incorporated by reference herein in its entirety.

### FIELD

Embodiments of the present disclosure relate generally to mobile display devices, and more particularly relate to a display device comprising a plurality of display screens thereon.

### BACKGROUND

A mobile electronic device exists that slidably connects two housings and provides a display module to both housings. A display device used for the mobile electronic device can display a variety of information on two display modules by sliding one housing toward a direction for opening so as to reach an open state.

When carrying the mobile electronic device, either one of the housings can slid in a direction for closing so as to reach a closed state. In this way, a compact state can be reached, in which only the display module on one side of the mobile electronic device is exposed and the display module on the other side is shielded.

In narrow places, crowded places, etc., there are circumstances in which a user may use the mobile electronic device in a half-open state. In the half-open state, the display module on the side that is shielded when the mobile electronic device is closed is partially exposed, and the remaining of the display module is shielded.

For cases in which an image is displayed on the display module in the open state and in which the mobile electronic device changes to the open state, some information may not visible.

### SUMMARY

A system and method for operating a mobile electronic device is disclosed. A shift of a first housing relative to a second housing comprising a display module is detected, and an amount of shielding of the display module by the first housing is determined. An image is displayed on the display module based on the amount of shielding. Therefore, display devices are provided with which information can be viewed even in a half-open state.

In an embodiment, a mobile electronic device comprises a first housing, a second housing, an exposure detection module, and a display control module. The second housing comprises a display module, and is coupled to the first housing. The second housing is operable to move relative to the first housing such that an amount of shielding of the display module changes in response to a movement of the second housing relative to the first housing. The exposure detection module is operable to detect a shift on the display module related to the movement, and the display control module is operable to display an image at a position corresponding to the shift.

In another embodiment, a method for operating a mobile electronic device comprises detecting a shift of a first housing relative to a second housing comprising a display module. The method further comprises determining an amount of shielding of the display module by the first housing, and displaying an image on the display module based on the amount of shielding.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure.

FIG. 1A is a perspective view of a mobile phone showing a front surface of a display device in a closed state according to an embodiment of the present disclosure.

FIG. 1B is a perspective view of the mobile phone showing a front surface of a display device in an open state according to an embodiment of the present disclosure.

FIG. 1C is a perspective view of the mobile phone showing the front surface of the display device in a half-open state according to an embodiment of the present disclosure.

FIG. 2 is a perspective view showing a rear surface of a mobile phone according to an embodiment of the disclosure.

FIG. 3 is a plan view of the mobile phone according to an embodiment of the disclosure.

FIG. 4 is an illustration of an exemplary functional block diagram of a mobile phone 100 according to an embodiment of the disclosure.

FIG. 5A is a plan view of the mobile phone according to an embodiment of the disclosure.

FIG. 5B shows an example of details of the dimensions stored in a dimension storage module according to an embodiment of the disclosure.

FIG. 6A is a plan view of the mobile phone in the state in which 0<EX<BH according to an embodiment of the disclosure.

FIG. 6B is a plan view of the mobile phone in the state in which the SH reaches 0 according to an embodiment of the disclosure.

FIG. 6C is a plan view of the mobile phone in the state in which the SH reaches the BH according to an embodiment of the disclosure.

FIG. 7 is an illustration of a display example of data that is displayed on a second touch panel according to an embodiment of the disclosure.

FIG. 8 is an illustration of a flow diagram of the display control processing according to an embodiment of the disclosure.

FIG. 9 is an illustration of a flow diagram of an identification processing of an amount of shielding according to an embodiment of the disclosure.

FIG. 10 is an illustration of a flow diagram of a display processing of a second touch panel according to an embodiment of the disclosure.

FIG. 11 is an illustration of a block diagram showing a configuration of a display function of a mobile phone according to an embodiment of the disclosure.

FIG. 12 is a diagram showing an exemplary display module in which an image is displayed on a first touch panel of the mobile phone according to an embodiment of the disclosure.

FIG. 13 is a diagram showing an exemplary display module on which an image is displayed on a second touch panel of a mobile phone according to an embodiment of the disclosure.

FIG. 14 is an illustration of a flow diagram of a display control processing of the mobile phone according to an embodiment of the disclosure.

FIG. 15 is an illustration of a flow diagram of a determination processing of a display mode according to an embodiment of the disclosure.

FIG. 16 is an illustration of a flow diagram of a division display control processing according to an embodiment of the disclosure.

FIG. 17 is an illustration of a flow diagram of a division display processing of the second touch panel according to an embodiment of the disclosure.

FIG. 18 is an illustration of a flow diagram of a division display processing of the first touch panel according to an embodiment of the disclosure.

FIG. 19 is a diagram showing one variation of the display mode according to an embodiment of the disclosure.

FIG. 20A is a perspective view showing a mobile electronic device that slides in an arc-shaped trajectory according to an embodiment of the disclosure.

FIG. 20B is a perspective view showing a mobile electronic device that changes an amount of shielding by folding the first housing according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, an information-processing device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, TV's, GPS's or navigation systems, pedometers, health equipments, display monitors, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

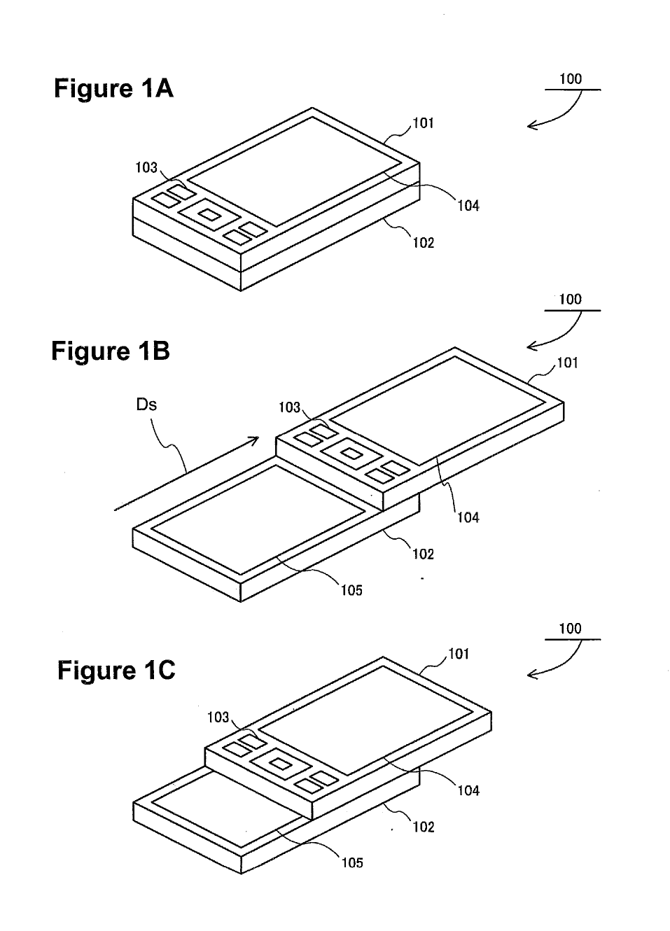

FIG. 1A is a perspective view showing a mobile phone 100 showing a front surface of a display device in a closed state according to an embodiment of the present disclosure. FIG. 1B is a perspective view of the mobile phone 100 showing a front surface of the display device in an open state according to an embodiment of the present disclosure. FIG. 1C is a perspective view of the mobile phone 100 showing the front surface of the display device in a half-open state according to an embodiment of the present disclosure.

The mobile phone 100 comprises a first housing 101 and a second housing 102. The mobile phone 100 is a so-called sliding type mobile phone, in which the first housing 101 and the second housing 102 are coupled via a sliding mechanism.

In the present disclosure, a sliding type mobile phone is used as an example of the mobile phone 100; however, the mobile phone 100 (mobile electronic device) is not limited to a sliding mobile phone as long as the mobile phone 100 is a mobile electronic device comprising a display module (display) in at least one of the two housings, and in which the amount of shielding SH on the display module changes depending on the movement of one of the housings.

The mobile phone 100 comprises keys 103 and a first touch panel 104 on a front side of the first housing 101, and comprises a second touch panel 105 on the front side of the second housing 102. The first touch panel 104 and the second touch panel 105 can have predefined shapes and sizes, respectively. In one embodiment, the first touch panel 104 and the second touch panel 105 may have substantially the same size. In FIG. 1, for example, the size of the first touch panel 104 and the second touch panel 105 is the same. Alternatively, the first touch panel 104 and a second touch panel 105 may have different sizes.

The second housing 102 may comprise a display module comprising the second touch panel 105 on the front side of the second housing 102, and is mechanically coupled to the first housing 101. The second housing 102 is operable to move relative to the first housing 101 such that an amount of shielding of the display module changes in response to a movement of the second housing 102 relative to the first housing 101 as explained in more detail below.

In the embodiments shown in FIGS. 1A to 1C, the first touch panel 104 and the second touch panel 105 are rectangular, however, the touch panels 104/105 are not limited to a rectangular shape. For example, the first touch panel 104 and/or the second touch panel 105 may be square, and the like.

In the closed state, a surface on which the second touch panel 105 of the second housing 102 is provided (hereinafter referred to as the front surface) is completely hidden. In the open state, the first housing 101 moves from the closed state in the sliding direction Ds, and an exposable section on the front side of the second housing 102 is completely exposed. In the half-open state, between the closed state and the open state, the front surface of the second housing 102 is partially exposed.

In this document, a direction, in which the first housing 101 is moved (slid) in order to open the mobile phone 100, is referred to as upward and the reverse direction thereof is referred to as downward.

The first touch panel 104 and the second touch panel 105 sense a touch of a finger, stylus, or the like. The first touch panel 104 and the second touch panel 105 may comprise a liquid-crystal display (LCD), or an organic electro-luminescence (OEL) panel, and the like, for displaying a screen, and a touch sensor for detecting a position of the touch.

The first touch panel 104 and the second touch panel 105 may each have a substantially rectangular shape (rectangular display). In this case, one side (a long side) of the rectangle may be parallel with the sliding direction Ds. The LCDs display image pixels for a predefined number, for example, 400 pixels may be displayed in a direction of the long side of the rectangular display, and 300 pixels may be displayed in the direction of a short side of the rectangular display, and the like. In this manner, an image with the predefined number of pixels can be displayed on the first touch panel 104 and the second touch panel 105.

The touch sensors of the first touch panel 104 and the second touch panel 105 comprise transparent materials located on surfaces of the LCDs by being overlapped on one another.

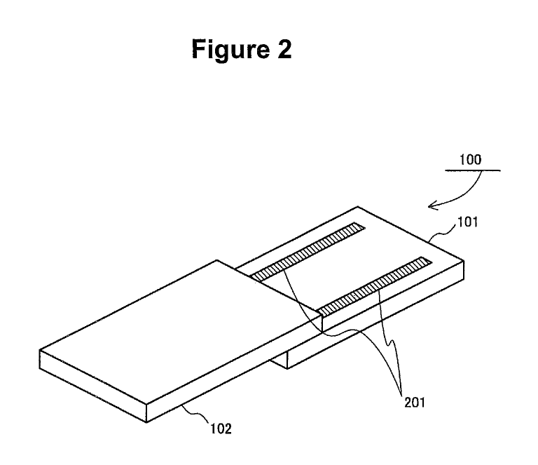

FIG. 2 is a perspective view showing a rear surface of the mobile phone 100 according to an embodiment of the disclosure. The mobile phone 100 comprises exposure detection modules 201 on the rear surface of the first housing 101 (on the side opposite from the front surface).

The exposure detection module 201 is operable to detect a shift on the display module related to the movement of the second housing 102 relative to the first housing 101. The exposure detection modules 201 comprises a linear resistive element and a slider that slides above the linear resistive element, and detect an exposure EX by reading out a resistance value of the resistive element with which the slider comes in touch. Based on characteristics of the resistive element, the resistance value is converted to millimeters (mm) and is output as the exposure EX.

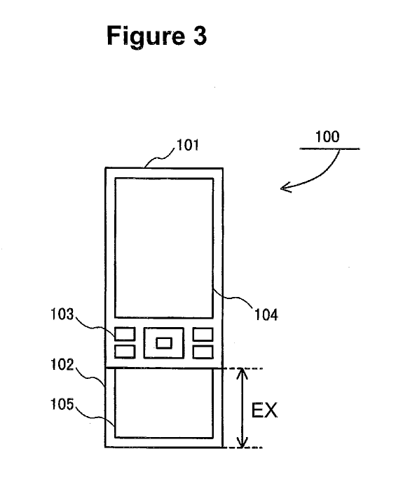

FIG. 3 is a plan view of the mobile phone 100 according to an embodiment of the disclosure. A value of the exposure EX is indicated by a vertical length EX of a section by which the front surface of the second housing 102 is exposed.

For example, in an open state the vertical length EX is 50 mm, and the exposure EX is 50, and in a closed state, the vertical length EX reaches a minimum value of 0. Moreover, in the open state, assuming that the vertical length EX can be opened up to 90 mm, the exposure EX in the open state reaches a maximum value of 90.

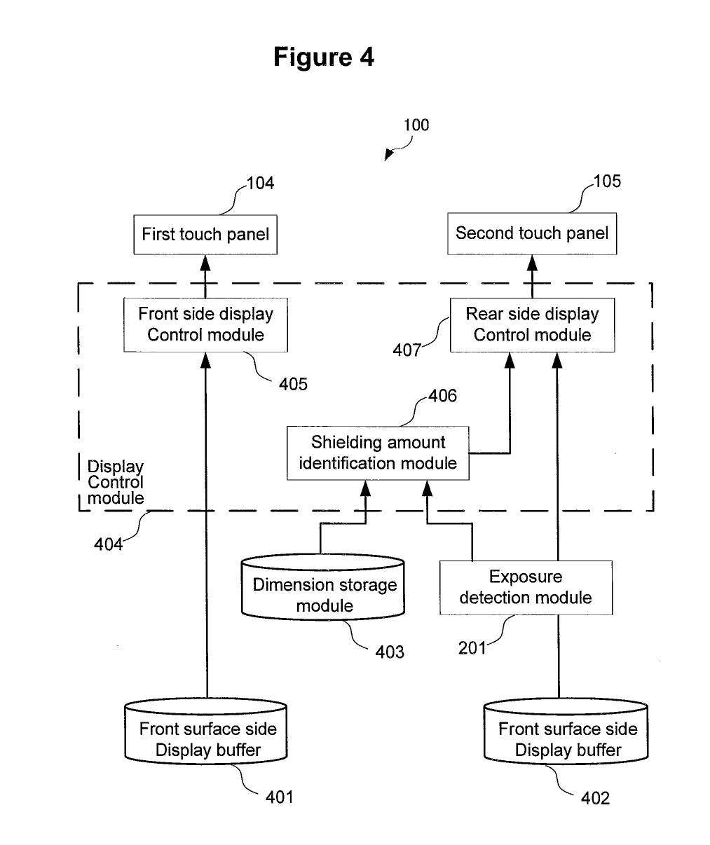

In addition, the mobile phone 100 comprises a memory and a processor (not shown), as well as other hardware generally found in mobile phones, such as a calling means. The memory and processor may be provided in either the first housing 101 or the second housing 102. The processor (control module) controls a display control module 404 (FIG. 4), the first touch panel 104, and the second touch panel 105 to display input/output parameters, image data, and the like. Further, the processor accesses the memory such as access to programs to direct operation of, the display control module 404, a front side display control module 405, a shielding amount identification module 406, and a rear side display control module 407 (FIG. 4) to display images, and the like .

The processor, may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like.

The memory may be any suitable data storage area with suitable amount of memory that is formatted to support the operation of the system. The memory is configured to store, maintain, and provide data as needed to support the functionality of the system in the manner described below. In practical embodiments, the memory may comprise, for example but without limitation, a non-volatile storage device (non-volatile semiconductor memory, hard disk device, optical disk device, and the like), a random access storage device (for example, SRAM, DRAM), or any other form of storage medium known in the art. The memory may be coupled to the processor and configured to store, for example but without limitation, the input parameter values and the output parameter values, such as an amount of the shift, and the like.

FIG. 4 is an illustration of an exemplary functional block diagram of a mobile phone 100 according to an embodiment of the disclosure. The mobile phone 100, in addition to the first touch panel 104, the second touch panel 105, and the exposure detection module 201, mentioned above, comprises a front surface side display buffer 401, a rear side display buffer 402, a dimension storage module 403, and a display control module 404.

The front surface side display buffer 401 comprises a memory area that stores an image showing information to be displayed on the first touch panel 104 (hereinafter referred to as the front side image).

The rear side display buffer 402 comprises a memory area that stores the image showing the information to be displayed on the second touch panel 105 (hereinafter referred to as the rear side image).

The front side image and the rear side image have the same number of pixels as the number of pixels for the first touch panel 104 and the second touch panel 105, respectively, and are both generated as application programs that control the mobile phone 100. This application programs generate the front side image and the rear side image in the open state, according to display areas of the first touch panel 104 and the second touch panel 105. For this type of application programs, for example, there is an application program that views e-mails.

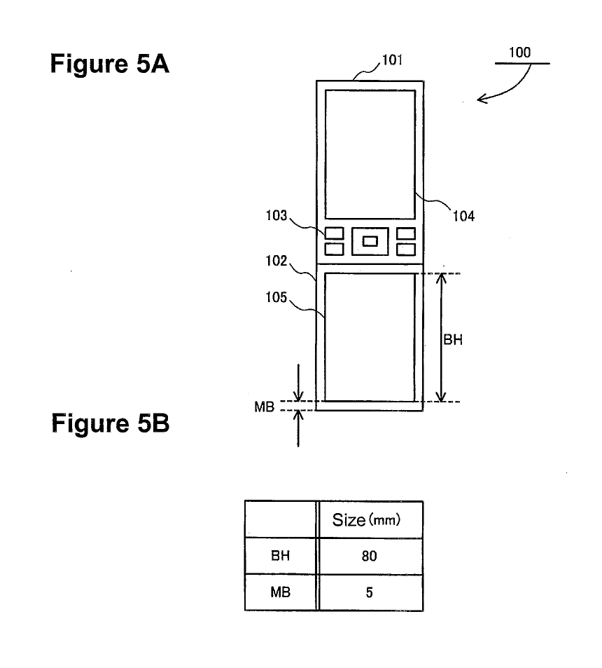

The dimension storage module 403 comprises a memory area that stores a dimension data. As shown in FIG. 5A, the dimension may comprise, for example but without limitation, a length of the long side of the second touch panel 105 (BH) and the distance (MB) from a lower edge of the second touch panel 105 to a lower edge of the second housing 102, and the like.

FIG. 5B shows an example of details of the dimension data stored in the dimension storage module 403. The dimension data is stored in units of millimeters (mm). In the example shown in FIG. 5B, BH is 80 mm and MB is 5 mm. This shows that the length of the long side BH of the second touch panel 105 is 80 mm, and the distance MB from the lower edge of the second touch panel 105 to the lower edge of the second housing 102 is 5 mm.

The display control module 404 controls display of an image on the first touch panel 104 and the second touch panel 105. The display control module 404 comprises the front side display control module 405 and displays the front side image displayed on the first touch panel 104, the shielding amount identification module 406, and the rear side display control module 407.

The front side display control module 405, the shielding amount identification module 406, and the rear side display control module 407 operate under direction of the processor (control module) that executes related programs stored in the memory as explained above.

The shielding amount identification module 406 identifies an amount of shielding of the display module based on the shift. In this manner, the shielding amount identification module 406 identifies the amount of shielding SH by which the second touch panel 105 is shielded by the first housing 101.

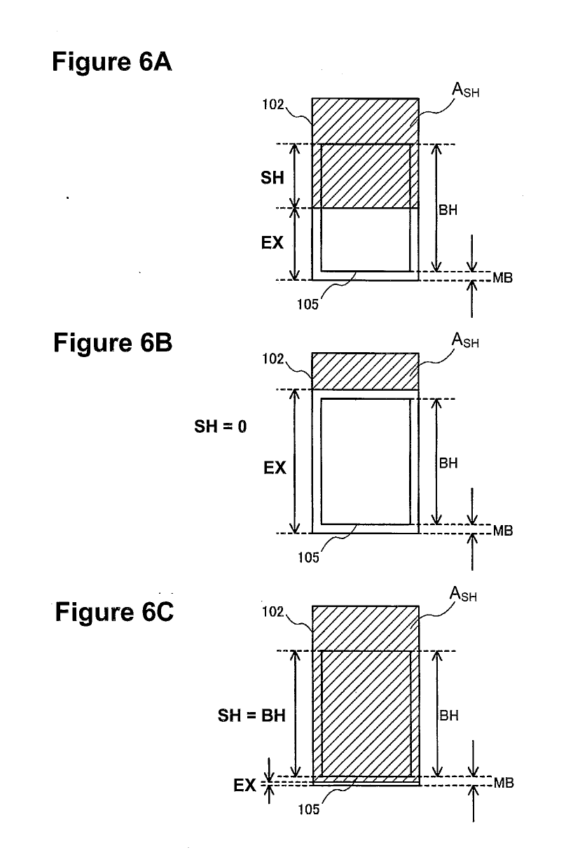

FIG. 6A is a plan view of the mobile phone 100 in a state in which 0<EX<BH. FIG. 6B is a plan view of the mobile phone 100 in a state in which the SH reaches 0. FIG. 6C is a plan view of the mobile phone 100 in a state in which the SH reaches the BH. In these Figures, an area A_{SH} that is covered by diagonal lines shows the shielded sections.

For cases in which some of the second touch panel 105 is shielded (MB<Exposure EX<BH+MB), a sum of the amount of shielding SH and the exposure EX is equivalent to a sum of the BH and the MB. In this case, the amount of shielding SH can be calculated by BH+MB−Exposure EX.

When the second touch panel 105 is completely exposed (Exposure EX≧BH+MB), the amount of shielding SH reaches 0.

When the second touch panel 105 is completely shielded (Exposure EX≦MB), the amount of shielding SH is equivalent to the BH.

The rear side display control module 407 generates an output image to the second touch panel 105, from the rear side image, and causes the rear side image to be displayed on the second touch panel 105.

However, for cases when SH=0, the rear side image may be displayed as is on the second touch panel 105. For cases when SH=BH, for energy saving purposes, a backlight of the second touch panel 105 may be turned off; however, if energy saving is not being considered, the backlight may not have to be turned off. For the case in which SH>0, the output image may be generated and displayed.

Generation of the output image, with respect to an image with a predefined number of pixels, is performed by drawing the rear side image such that the upper edge of the rear side image is positioned below the upper edge of the image by the amount of shielding SH only. Here, “upper” and the “lower” in the image refer to the upper and lower directions where the image is displayed on the first touch panel 104 or the second touch panel 105. The image may comprise, for example but without limitation, a text, a symbol, a graphic, and the like.

Moreover, a draw position is expressed by a number of pixels for the image, and because the amount of shielding SH is expressed in units of millimeters, the draw position is identified by converting from the positions in units of millimeters to the coordinate value shown in units of the number of pixels, using the resolution of the display module of the second touch panel 105. Here, the coordinate value is shown in the coordinate, namely (x, y), in which the top left edge is assumed to be the origin (0, 0).

Below, for cases in which the image is drawn using the position in units of millimeters, drawing processing is carried out by identifying the coordinate value as in the above case and by applying the coordinate value to the drawing functions that are prepared in advance.

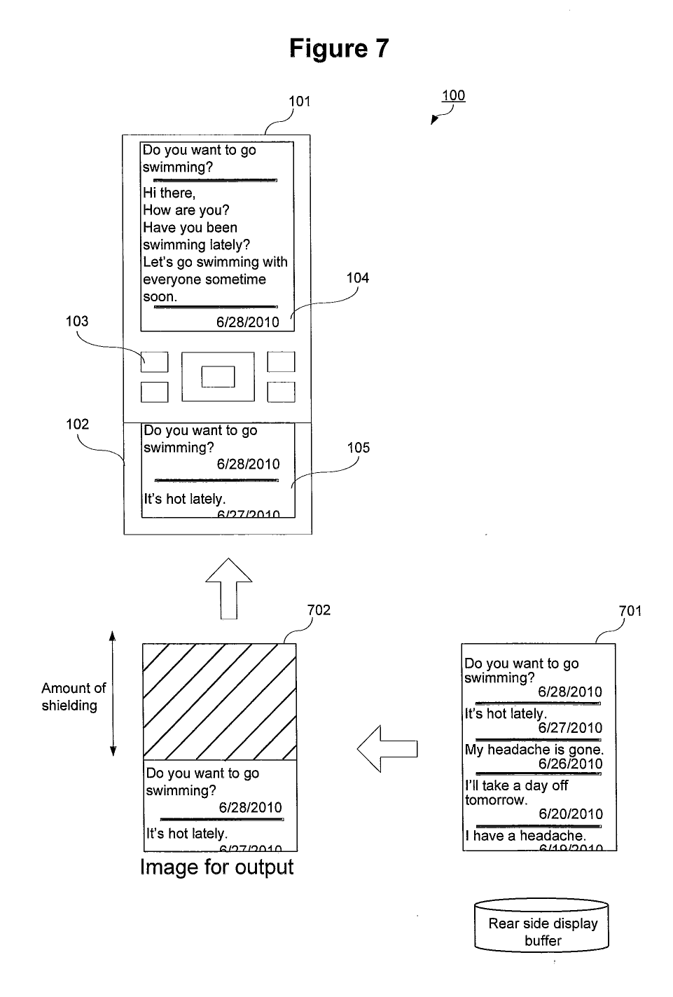

FIG. 7 is an illustration of a display example of data that is displayed on the second touch panel 105 according to an embodiment of the disclosure.

The image generated by the rear side display control module 407 and the display example are shown. To the rear side display buffer 402, a display image 701, which is a list of e-mails, is stored, as the rear side image. The rear side display control module 407 generates an image 702, by drawing the display image 701 such that the top edge of the display image 701 is positioned below the top edge of the image by the amount of shielding SH only. Moreover, when the image 702 output is displayed on the second touch panel 105, the display mode in which the upper edge of the display image 701 comes in contact with the lower edge of the first housing 101 is reached.

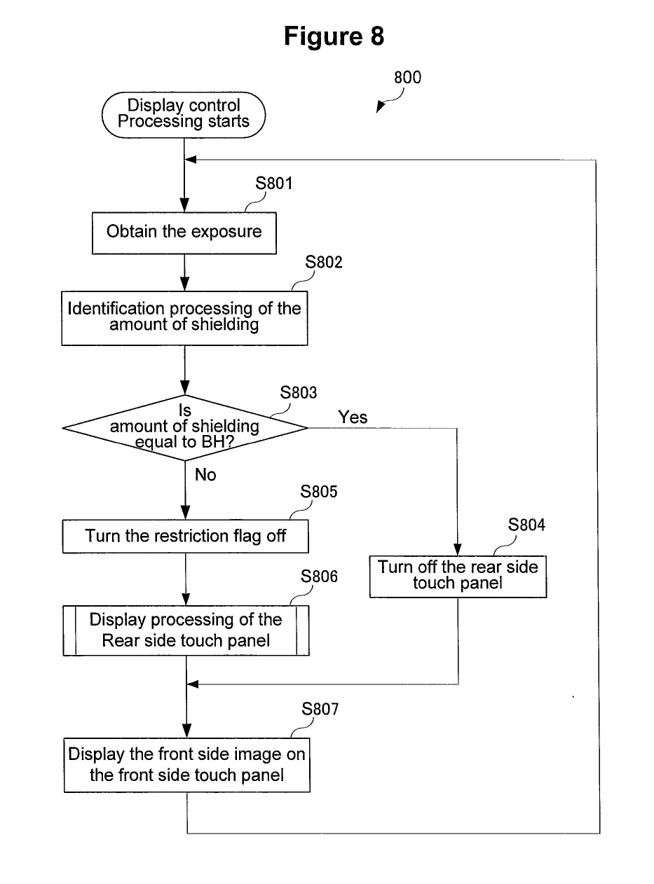

FIG. 8 is an illustration of a flow diagram of the display control processing according to an embodiment of the disclosure.

First, the shielding amount identification module 406 obtains the exposure EX detected by the exposure detection module 201 (task S801), and identifies the amount of shielding SH (task S802). Identification processing of the amount of shielding SH is described subsequently.

When the amount of shielding SH is identified, the rear side display control module 407 determines whether or not the amount of shielding SH is equivalent to the BH (task S803).

When the amount of shielding SH is equivalent to the BH task S803: YES branch), the rear side display control module 407 turns off the backlight of the second touch panel 105 (task S804).

When the amount of shielding SH is not equivalent to the BH (task S803: NO branch), the rear side display control module 407 turns on the backlight of the second touch panel 105 (task S805), and carries out display processing of the second touch panel 105 (task S806). Display processing of the second touch panel 105 is described subsequently.

The front side display control module 405 displays the front side image as is on the first touch panel 104 (task S807), and returns to the task S801.

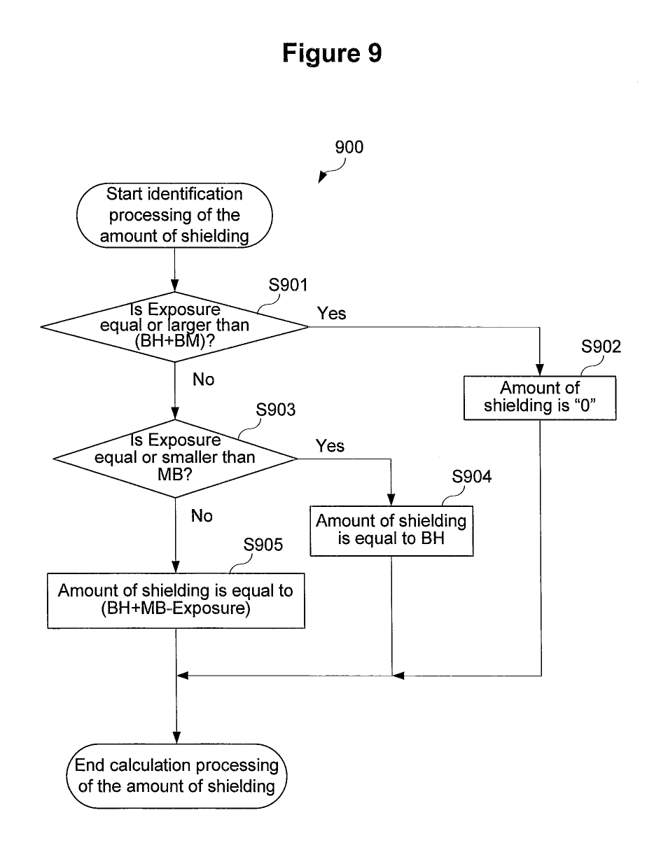

FIG. 9 is an illustration of a flow diagram of an identification processing of an amount of shielding according to an embodiment of the disclosure. Next, the identification processing of the amount of shielding SH performed by the shielding amount identification module 406 is explained.

The shielding amount identification module 406, first, determines whether or not the exposure EX exceeds BH+MB (task S901), and if it exceeds BH+MB (task S901: YES branch), shielding amount identification module 406 identifies the amount of shielding SH to be 0 (task S902).

When the exposure EX falls below BH+MB (task S901: NO branch), the shielding amount identification module 406 determines whether or not the exposure EX falls below the MB (task S903).

When the exposure EX falls below the MB (task S903: YES branch), the shielding amount identification module 406 identifies the amount of shielding SH to be the BH (task S904). When the exposure EX exceeds the MB (task S903: NO branch), the amount of shielding SH is identified as BH+MB−Exposure EX (task S905).

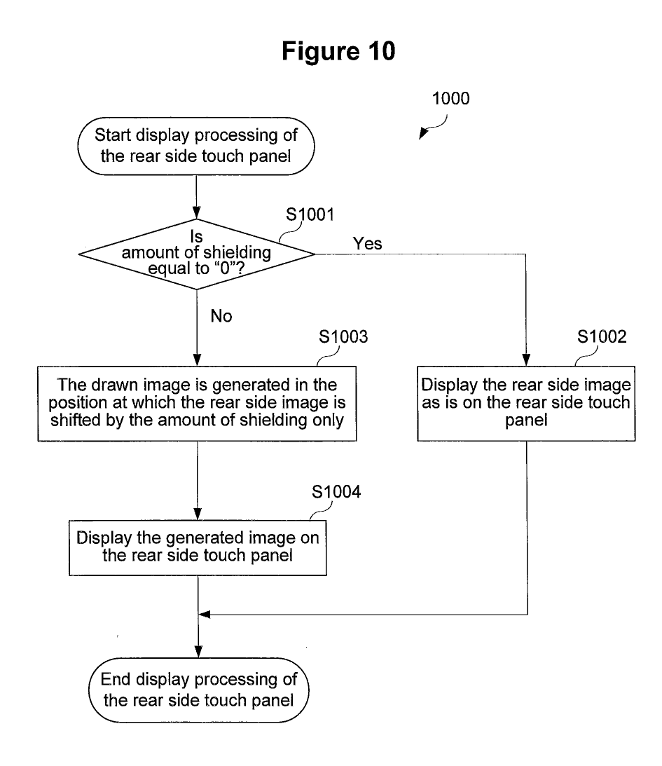

FIG. 10 is an illustration of a flow diagram of a display processing of the second touch panel 105 according to an embodiment of the disclosure. The display processing of the second touch panel 105 performed by the rear side display control module 407 is explained below.

The rear side display control module 407 first determines whether or not the amount of shielding SH is 0 (task S1001), and if it is 0 (task S1001: YES branch), the rear side display control module 407 displays the rear side image as is on the second touch panel 105 (task S1002).

If the amount of shielding SH is not 0 (task S1001: NO branch), the rear side display control module 407 generates the output image according to the amount of shielding SH, as described below (task S1003).

A new coordinate (x, y+α) is identified, in which the value (α) that converted the amount of shielding SH to the number of pixels is added to the y coordinate of the coordinate (x, y) showing the drawing start position for cases in which the rear side image is displayed in the open state.

The output area corresponding to the number of pixels of the second touch panel 105 is confirmed, with the new coordinate applied to the drawing function with respect to the output area that is confirmed, and the rear side image is drawn.

Moreover, in the output area, the sections in which the rear side image is not drawn may be painted with a background color (for example, black). Instead of painting the area in which the rear side image is not drawn, some display types other than a background color may also be carried out.

The rear side display control module 407 causes images for output that are generated in this way (task S1004) to be displayed on the second touch panel 105.

In this way, as shown in FIG. 7, the display position of the rear side image shifts from the original display position to the downward direction by the amount of shielding SH only, to provide a shifted position; therefore, on the section that is not shielded, the upper section of the rear side image can be displayed.

Therefore, for cases in which important information is included in the upper section of the rear side image (in the example from FIG. 7, the latest e-mail), it is possible for useful information to be viewed even in the half-open state. Therefore, any inconvenience caused at the time of viewing the information is reduced.

In one embodiment, the first touch panel 104 may be omitted so as to display the image on the second touch panel only.

According to one embodiment, the mobile phone 100 comprises two display modes, a normal display mode and a division display mode, and the display mode can be switched by a touch operation to the second touch panel 105.

A size of the first touch panel 104 and the second touch panel 105 may be the same or different. When the size differs, depending on the difference in size of the image for the division display, the size and the position of the sections of the rear side image displayed on the first touch panel 104 may be adjusted.

Here, the normal display mode refers to the display mode that performs the display, as explained above. Below, the normal display mode is simply referred to as the “normal display.”

The division display mode refers to the display mode that displays images by dividing the rear side image into the exposed section of the second touch panel 105 and some section of the first touch panel 104. Below, the division display mode is simply referred to as the “division display.”

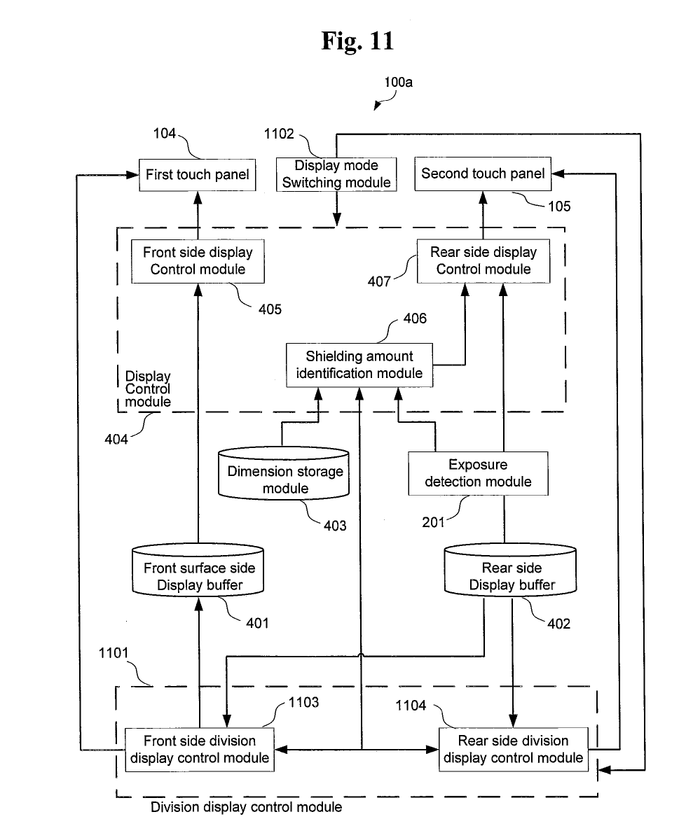

The configuration according to the display function of the display device 100a is such that, as shown in FIG. 11, in addition to the configuration for the mobile phone 100, it comprises a division display control module 1101 and a display mode switching module 1102.

FIG. 11 is an illustration of a block diagram showing a configuration of a display function of the mobile phone 100 according to an embodiment the disclosure.

The division display control module 1101 comprises a front side division display control module 1103 and a rear side division display control module 1104, and controls the division display.

A display mode switching module 1102 is operable to switch between a full display and a partial display, according to a predefined operation by a user. The display mode switching module 1102 comprises a storage area for storing the display mode which switches the display mode alternately between the normal display and the division display when specific operations are detected. The specific operations are, for example, a touch of the second touch panel 105. Instead of by touch, the specific operations may be slide or flick operations. The specific operations may be the operation on the first touch panel 104, the keys 103, etc. Switching between the normal display and the division display may not be performed with the same operation but may be performed with a different operation. For example, switching from the normal display to the division display may be performed when a touch of the second touch panel 105 is detected, and switching from the division display to the normal display may be performed when a touch of the first touch panel 104 is detected.

Switching from the normal display to the division display may be expressed by animations such that the switching is seen as a gradual transition. Switching from the division display to the normal display may also be expressed by contrasting animations.

When the display mode is switched to the normal display, the display mode switching module 1102 operates the front side display control module 405 and the rear side display control module 407 of the display control module 404, and does not operate the front side division display control module 1103 or the rear side division display control module 1104 of the division display control module 1101.

When the display mode is switched to the division display, the display mode switching module 1102 operates the front side division display control module 1103 and the rear side division display control module 1104 of the division display control module 1101, and does not operate the front side display control module 405 or the rear side display control module 407 of the display control module 404.

Moreover, the display mode immediately after starting the display device 100a is set to the normal display.

The front side division display control module 1103 generates the output image to the first touch panel 104 and causes it to be displayed on the first touch panel 104.

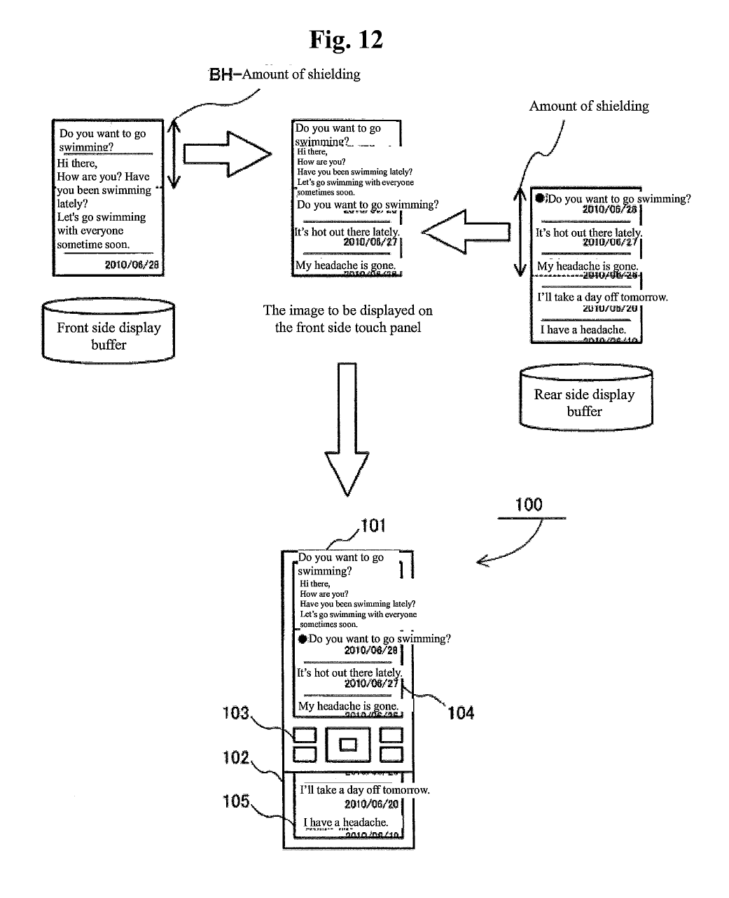

FIG. 12 is a diagram showing an exemplary display module in which an image is displayed on the first touch panel 104 of the mobile phone 100. Generation of an output image to the first touch panel 104 is performed by drawing the upper section of the front side image on the upper side, and the section of the size for the amount of shielding SH from the top the rear side image on the lower side. However, for cases when SH=0, the front side image is displayed as is, and for cases when SH=BH, the rear side image is displayed as is, and the output image is not generated. The rear side division display control module 1104 causes the lower module of the rear side image to be displayed on the second touch panel 105.

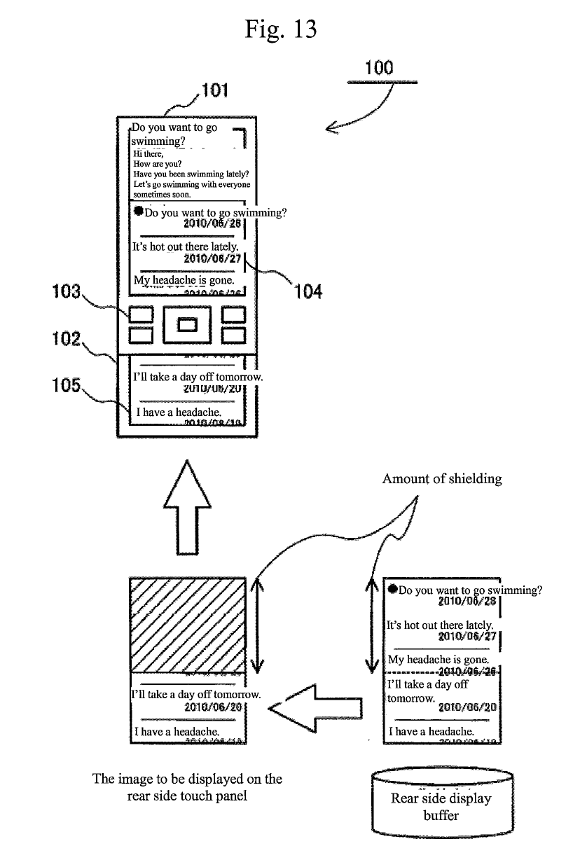

FIG. 13 is a diagram showing an exemplary display module on which an image is displayed on the second touch panel 105 of the mobile phone 100 according to an embodiment the disclosure. An image is generated in which a section is removed for the amount of shielding SH only from above the rear side image, and the generated image is displayed on the second touch panel 105. However, for cases when SH=0, the rear side image is displayed as is on the second touch panel 105. For cases when SH=BH, for energy saving purposes, the backlight of the second touch panel 105 is turned off. The operations of the display device 100a are such that the following operations are different from the mobile phone 100, while other operations remain the same.

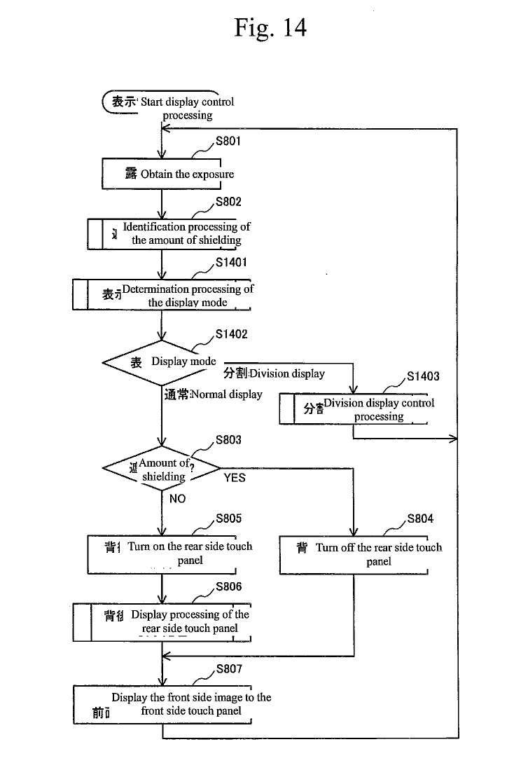

FIG. 14 is an illustration of a flow diagram of a display control processing of the mobile phone according to an embodiment the disclosure. For display control processing, after the identification processing of the amount of shielding SH (task S802), determination processing of the display mode (task S1401), which is described subsequently, and determination of the display mode performed by the display mode switching module 1102 (task S1402) are added.

As a result of the determination at the task S1402, for cases in which the display mode is the normal display (task S1402: normal display), the processes from the task S802 onward are performed. For cases in which the display mode is the division display (task S1402: division display branch) division display control processing (task S1403), which is described subsequently, is performed.

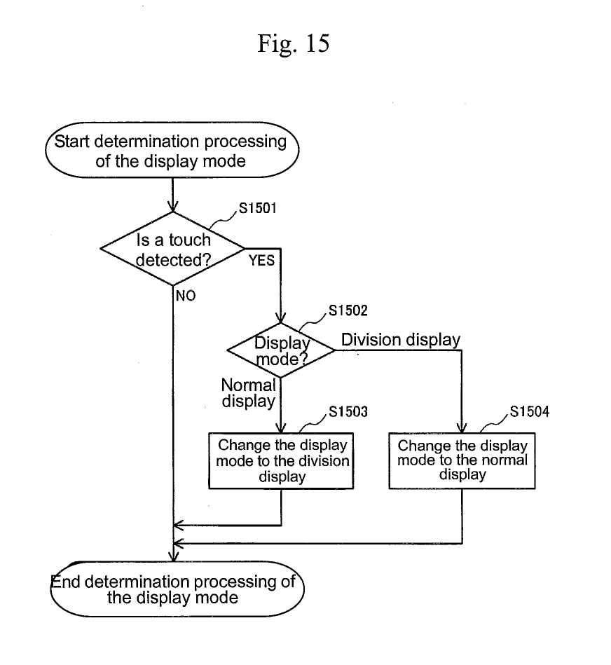

FIG. 15 is an illustration of a flow diagram of a determination processing of a display mode according to an embodiment the disclosure. Next, determination processing of the display mode, which is added, is described.

First, the display mode switching module 1102 determines whether or not a touch is detected in the second touch panel 105 (task S1501), and if it is determined that a touch is detected (task S1501: YES branch), it determines the current display mode (task S1502).

When the current display mode is the normal display (task S1502: normal display branch), the display mode switching module 1102 changes the display mode to the division display (task S1503). When the current display mode is the division display (task S1502: division display branch), it changes the display mode to the normal display (task S1504).

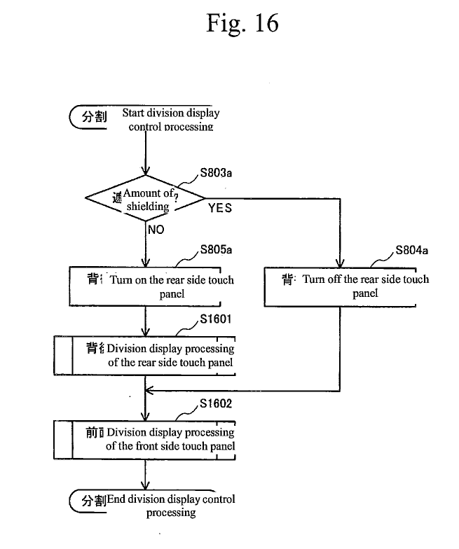

FIG. 16 is an illustration of a flow diagram of a division display control processing according to an embodiment the disclosure. Division display control processing carried out by the division display control module 1101 is explained.

First, the rear side division display control module 1104 determines whether or not SH=BH (task S803a), and according to the determination results, the second touch panel 105 is turned on or turned off (task 5804a, S805a). This processing is equivalent to the processing the task S803 to 5805 performed by the rear side display control module 407.

After the task 5805a, the rear side division display control module 1104 carries out division display processing of the second touch panel (task S1601).

After the tasks S804a and S1601, the front side division display control module 1103 carries out division display processing of the first touch panel (task S1602).

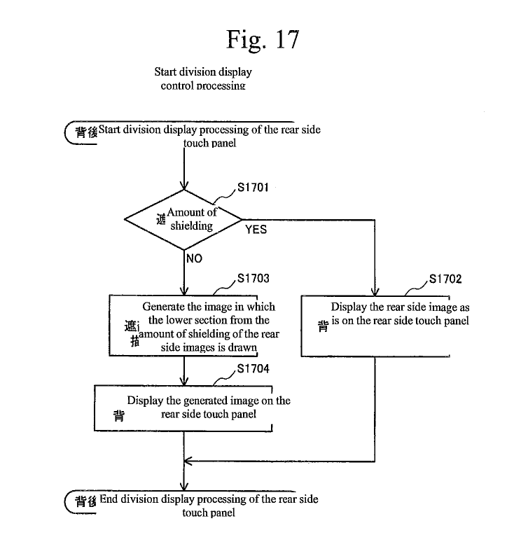

FIG. 17 is an illustration of a flow diagram of a division display processing of the second touch panel according to an embodiment the disclosure. First, the rear side division display control module 1104 determines whether or not SH=0 (task S1701), and if it is determined that it is 0 (task S1701: YES branch), the rear side image is displayed as is on the second touch panel 105 (task S1702).

For cases when SH≠0 (task S1701: NO branch), the rear side division display control module 1104 generates an output image that can be created by drawing the lower section of the amount of shielding SH of the rear side image (task S1703).

Generation of the output image is performed by confirming the output area corresponding to the number of pixels of the second touch panel 105, and by drawing the section which is the amount of shielding SH to BH, from the upper edge of the rear side image, at the section which is the amount of shielding SH to BH, from the upper edge of the area thereof.

Here, the section in which the rear side image is not drawn in the output area is painted with a background color.

For example, for cases in which the amount of shielding SH is 50 mm, considering that the image is displayed on the second touch panel 105, with the length of the long side being 80 mm, the section corresponding to 50 mm to 80 mm from the upper edge of the rear side image is drawn to the section which is 50 mm to 80 mm from the upper edge of the output area. Moreover, the section which is 0 mm to 50 mm from the upper edge of the output area is painted with a background color.

Moreover, the generated output image is displayed on the second touch panel 105 (task S1704).

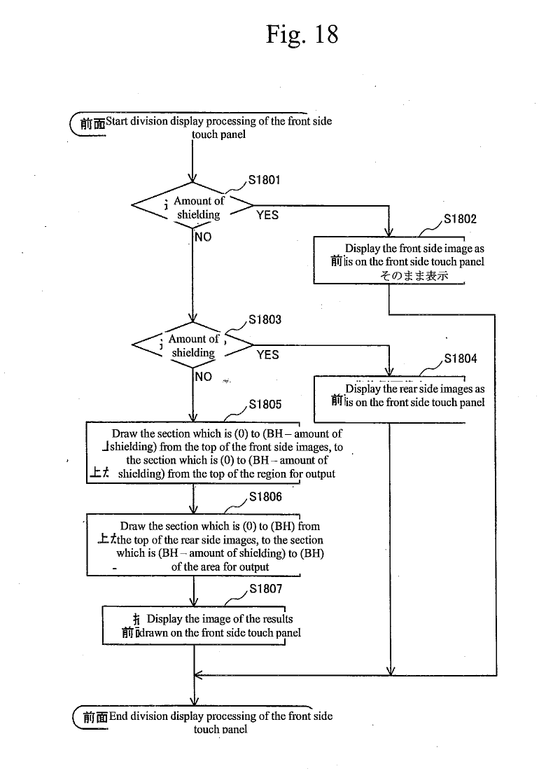

FIG. 18 is an illustration of a flow diagram of a division display processing of the first touch panel according to an embodiment the disclosure.

First, the front side division display control module 1103 determines whether or not SH=0 (task S1801), and if it is determined that it is 0 (task S1801: YES branch), the front side image is displayed as is on the first touch panel 104 (task S1802).

For cases when SH≠0 (task S1801: NO branch), the front side division display control module 1103 determines whether or not SH=BH (task S1803).

For cases when SH=BH (task S1801: YES branch), the front side division display control module 1103 causes the rear side image to be displayed on the first touch panel 104 (task S1804).

For cases when SH≠BH (task S1803: NO branch), the output image is generated as follows and is displayed on the first touch panel 104.

First, the front side division display control module 1103 confirms the output areas corresponding to the number of pixels of the first touch panel 104, and draws the section which is 0 to (BH−SH) from the upper edge of the front side image, at the section which is 0 to (BH−SH) from the upper edge of the output area (task S1805).

Moreover, the section which is 0 to SH from the upper edge of the rear side image, is drawn to the section which is (BH−SH) to SH from the upper edge of the output area (task S1806).

In this way, the generated output image is displayed on the first touch panel 104 (task S1807).

An example is considered in which, when the SH is 50 mm, the image is displayed on the first touch panel 104 with the length of the long side being 80 mm. First, the front side division display control module 1103 draws the section which is 0 mm to 30 mm from the upper edge of the front side image, to the section which is 0 mm to 30 mm (80 mm to 50 mm) from the upper edge of the output area. Moreover, the section which is 0 mm to 50 mm from the upper edge of the rear side image is drawn to the section which is 30 mm to 80 mm from the upper edge of the output area.

For cases in which a plurality of backlights is present in the second touch panel 105, the respective backlights may be individually controlled according to the SH. For example, the backlights corresponding to the section that is not visible because it is shielded by the first housing 101 can be set so as to be turned off.

For the abovementioned normal display, by sliding with respect to the first touch panel 104 so as to approach from the bottom to the top, the rear side image may be displayed on the first touch panel 104 so as to follow the slide operation and be pulled out. The slide operation with respect to the touch panel refers to the operation by which an indicator substance is brought into contact with a given indication position above the touch panel, and by which the indication position is moved while the indicator substance is brought into contact.

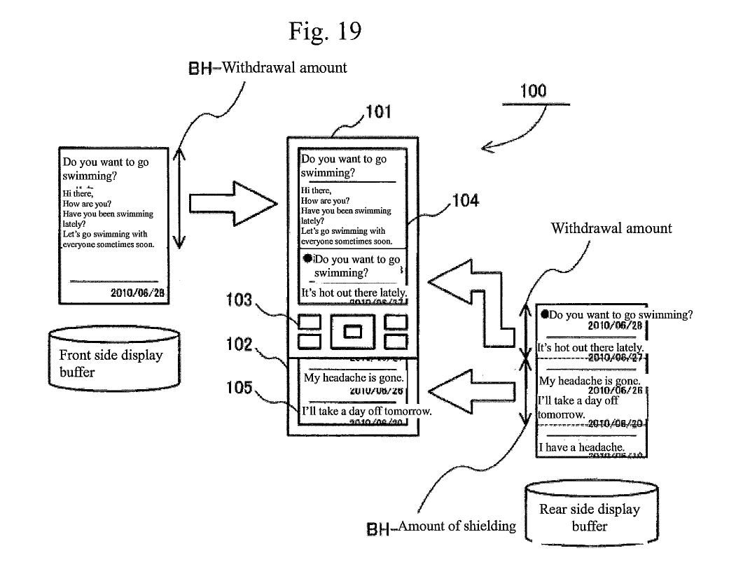

FIG. 19 is a diagram showing one variation of the display mode according to an embodiment the disclosure. For example, it may be such that by assuming the shift of the slide operation with respect to the first touch panel 104 as the withdrawal amount, the section which is the withdrawal amount to (withdrawal amount+BH−SH) from the upper edge of the rear side image, is displayed on the second touch panel 105, and the section which is 0 to (BH−withdrawal amount) from the upper edge of the front side image, and the section which is 0 to the withdrawal amount from the upper edge of the rear side image, are displayed on the first touch panel 104.

For cases in which the range of the section of the rear side image to be displayed exceeds the rear side image, that is, for cases in which (withdrawal amount+BH−SH)>BH (withdrawal amount>SH), the exceeded amount may be treated as follows.

(a) The rear side image may be stretched and displayed.

(b) Some of the sections of the front side image that is not displayed on the first touch panel 104 may be displayed.

(c) Images that fall under neither of the above may be displayed. For example, if the rear side image shows a list of e-mails, an image showing continuation of the list, etc., may be used.

(d) It may be painted with a background color.

The withdrawal amount may also be saturated with the size of the amount of shielding SH and the range of the section of the rear side image to be displayed may be set so as not to exceed the rear side image.

At the task S1806, with the division display, when some of the rear side image is displayed on the first touch panel 104, it may be synthesized with the section which is (BH−SH) to BH from the upper edge of the front side image, and translucency in order to be displayed.

In the division display, by operations such as touching of the first touch panel 104, the aspect in which some of the rear side image is displayed as is and the aspect in which it is synthesized with translucency and the front side image may be switched.

In the normal display, resulting from the slide operation with respect to the first touch panel 104 or the second touch panel 105, the display details of the second touch panel 105 may be scrolled.

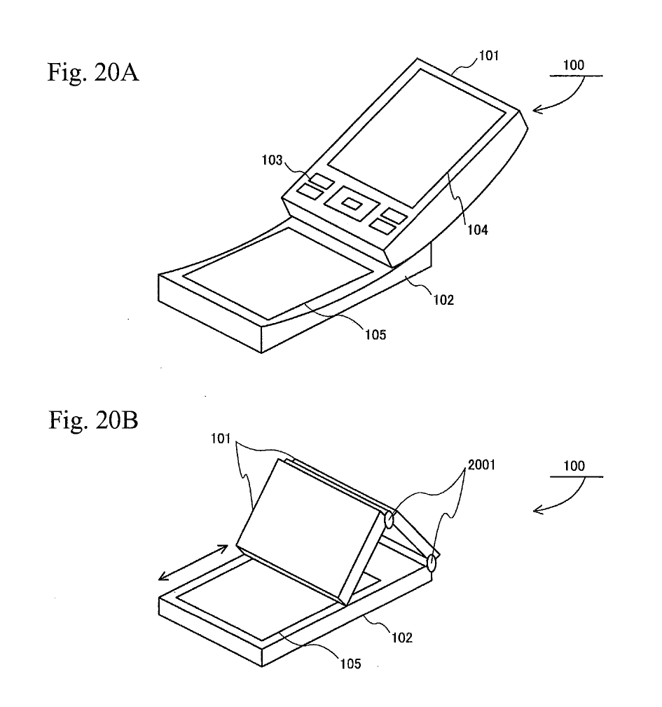

FIG. 20A is a perspective view showing a mobile electronic device that slides in an arc-shaped trajectory according to an embodiment the disclosure. FIG. 20 B is a perspective view showing a mobile electronic device that changes the amount of shielding by folding the first housing 101 according to an embodiment the disclosure. In the above embodiments, the mobile phone 100 that slides linearly has been described; however, it may be a mobile phone that slides in an arc-shaped trajectory, as shown in FIG. 20A.

In the above embodiments, the mobile phone 100 comprising 2 housings, the first housing 101 and the second housing 102, has been described; however, it may be a mobile phone that is constituted by coupling a separate housing to both housings or either one of the first housing 101 and the second housing 102, and that is constituted by connecting 3 housings or more.

In the above embodiments, it was described that the exposure EX is the value showing the vertical length of the section in which the front surface of the second housing 102 is exposed; however, as long as the value changes depending on the movement of the first housing 101, other values may be used.

For example, the value showing the distance from the position of the first housing 101 in the open state to the current position of the first housing 101 may be used. In such cases, the calculation method for the amount of shielding SH is changed.

In the above embodiments, it was described that the exposure detection module 201 outputs the exposure EX with the value in units of millimeters; however, values in other units of measurement may be output. Similarly, the data of dimensions stored in the dimension storage module 403 may be of values in dimensions other than millimeters.

For example, the exposure EX may be set to be the value in units of the number of pixels. With this, if the values, such as the amount of shielding SH, BH, and MB, are managed in units of the number of pixels, calculations for converting from millimeters to the number of pixels is no longer necessary.

In the above embodiments, the example in which the exposure detection module 201 is disposed at 2 locations on the rear surface of the first housing 101, has been described; however, as long as the exposure EX can be detected, it does not matter how it is disposed.

For example, the exposure EX may be disposed on the front surface of the second housing 102, or the exposure EX may be disposed at one location only. Moreover, the exposure EX may be disposed on both the first housing 101 and the second housing 102.

In the above embodiments, the settings were such that the exposure detection module 201 comprises the resistive elements; however, as long as the exposure EX can be detected, any method can be used to achieve this. For example, the exposure EX may be detected by arranging the optical sensors in a linear fashion and according to how many optical sensors are used to detect the light. Moreover, the exposure EX may be detected by the capacitance between the two metal plates by pasting metal plates respectively at two locations corresponding to the rear surface of the first housing 101 and the front surface of the second housing 102.

In the above embodiments, the settings were such that the amount of shielding SH is identified from the calculation using BH+MB−EX; however, the amount of shielding SH may be identified by further adding a predefined amount to this.

An example is considered of cases in which the detected exposure EX is detected as a value exceeding the actual exposure EX, resulting from errors. If the predefined amount is not added, the amount of shielding SH becomes smaller than the actual amount that is shielded, the upper edge of the rear side image is placed at the position higher than the lower edge of the first housing 101, and some of the rear side image on the upper side will be hidden. On the other hand, if the size of errors obtainable by the exposure detection module 201 is added as the predefined amount, in these cases, the amount by which the amount of shielding SH decreased resulting from the errors can be cancelled, preventing the upper side of the rear side image from being hidden.

For example, assuming that the exposure detection module 201 outputs the exposure EX in a discrete value in increments of 1 millimeter, errors up to ±1 millimeter occur. Therefore, as the predefined amount, if 1 millimeter is added to the amount of shielding SH, 1 millimeter of the upper side of the rear side image can be prevented from being hidden.

Depending on the operation by the user, the size of the amount of shielding SH may also be changed from BH+MB−EX. For example, as a result of the operation by the keys 103, the amount of shielding SH may be set such that it can be adjusted.

In the above embodiments, an example was described in which the images showing varying information were displayed on the first touch panel 104 and the second touch panel 105; however, it may be such that one large image is displayed on both the first touch panel 104 and second touch panel 105 touch panels.

In the above embodiments, it is described that the keys 103 for operating are provided on the front surface of the first housing 101; however, this need not be the case. For example, they are not necessary for cases in which all the operations can be performed with the touch panel.

On the other hand, if all the operations can be performed with the keys 103, the first touch panel 104 and second touch panel 105 can be LCDs instead of the touch panels 104/105.

In this way, the display position of the image shifts from the original display position by the shielded amount only; thereby, making it possible to display the important section of the image on the section that is not shielded.

In the above embodiments, a second display module is achieved by the first touch panel 104, a division display control means is achieved by the division display control module 1101, and a switching means is achieved by the display mode switching module 1102.

In this way, for cases in which the user wants to see the entire image, by performing a predefined operation, not only does the user use the sections of a first display module that is not shielded, but the user also uses some of the second display module, in order to display the image.

Therefore, when the lower side of the image is not visible as a result of the display control means, using operations such as touch and flick with respect to the image thereof, it can be switched to a display in which the entire area of the image is visible, using the display control means.

This operation is performed with respect to the image itself that the user wants to see; therefore, compared to the operation of the keys, etc., which are located at positions unrelated to the image, the operations are intuitive and simple.

When a second image is displayed on the second display module, the second image of the section in which sub-images are displayed in the division display, is generally hidden; however, by setting in this way, the hidden section can also be verified.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
a first housing;
a second housing comprising a display module coupled to the first housing, and operable to move relative to the first housing such that an amount of shielding of the display module changes in response to a movement of the second housing relative to the first housing;
an exposure detection module operable to detect a shift on the display module related to the movement; and
a display control module operable to display an image at a position corresponding to the shift.

2. The mobile electronic device according to claim 1, wherein the image comprises at least one member selected from the group consisting of: a text, a symbol, and a graphic.

3. The mobile electronic device according to claim 1, wherein the display module comprises substantially a rectangular display and when the mobile electronic device is closed, a sliding direction of the second housing and one side of the rectangular display are substantially parallel to each other.

4. The mobile electronic device according to claim 1, further comprising a shielding amount identification module operable to identify the amount of shielding of the display module based on the shift.

5. The mobile electronic device according to claim 1, wherein the first housing comprises a first touch panel, the display module comprises a second touch panel, and the first touch panel and the second touch panel are parallel to each other.

6. The mobile electronic device according to claim 1, wherein the display control module is further operable to display the image in an open state, in which the display module is not shielded, at a shifted position at which the image is shifted from a display position at which the image is displayed in a direction, by the amount of shielding only.

7. The mobile electronic device according to claim 6, wherein:
the first housing comprises a first display module;
the display module comprises a second display module; and
the first display module and the second display module are substantially parallel to each other.

8. The mobile electronic device according to claim 7, further comprising:
a division display control module operable to display the image on the first display module, and in which to the second display module, in the open state, so as to be connected to an edge of the second display module for a side that approaches the first display module, control for displaying one or more sub-images of the image is performed; and
a display mode switching module operable to switch between a full display and a partial display, according to a predefined operation by a user, wherein the sub-images are sections, for the image, in the open state, that fall in a scope of a position that is away from the edge on a side that is displayed on a side that is near the second display module by the amount of shielding only.

9. The mobile electronic device according to claim 8, wherein:
the predefined operation comprises an operation of the first display module, and
the display mode switching module causes the control module to control the display, when the operation with respect to the first display module is detected.

10. The mobile electronic device according to claim 8, wherein the control module causes the second display module to display a second image, and wherein the display of the sub-images on the second display module is performed by synthesizing with the second image and translucency.

11. The mobile electronic device according to claim 1, wherein the shift comprises a distance by which the second housing moves, and the control module identifies a value in which a predefined amount is added to the shift, as the amount of shielding.

12. A method for operating a mobile electronic device comprising:
detecting a shift of a first housing relative to a second housing comprising a display module;
determining an amount of shielding of the display module by the first housing; and
displaying an image on the display module based on the amount of shielding.

13. The method according to claim 12, wherein the image comprises at least one member selected from the group consisting of: a text, a symbol, and a graphic.

14. The method according to claim 12, wherein the display module comprises substantially a rectangular display and when the mobile electronic device is closed, a sliding direction of the second housing and one side of the rectangular display are substantially parallel to each other.

15. The method according to claim 12, further comprising:
identifying the amount of shielding of the display module based on the shift; and
displaying the image, in an open state in which the display module is not shielded, at a position at which the image is shifted from a position at which the image is displayed in a direction, by the amount of shielding only.

16. The method according to claim 15, wherein:
the first housing comprises a first display module;
the display module comprises a second display module; and
the first display module and the second display module are substantially parallel to each other.

17. The method according to claim 16, further comprising:
displaying the image on the first display module such that the image continues to an edge of the second display module on a side near the first display module, when second display module is in the open state;
controlling display of one or more sub-images of the image; and
switching between a full display and a partial display according to a predefined operation by a user, wherein the sub-images are sections of the image in the open state that fall in a position that is away from an edge on a side that is displayed on a side that is near the second display module by the amount of shielding only.

18. The method according to claim 17, further comprising causing a control module to control the display, when the operation with respect to the first display module is detected, wherein the predefined operation comprises an operation of the first display module.

19. The method according to claim 18, further comprising:
causing the second display module to display a second image; and
displaying the sub-images on the second display module by synthesizing with the second image and translucency.

20. The method according to claim 18, further comprising identifying a value in which a predefined amount is added to the shift, as the amount of shielding, wherein the shift comprises a distance by which the second housing moves.
